(19) United States
(12) Patent Application Publication
(10) Pub. No.: US 2020/0093324 A1
(43) Pub. Date: Mar. 26, 2020

(54) Brush for Flat Bottom Semi-Globe Shaped Coffee Pots

(71) Applicant: Gregory Krantz, Howell, MI (US)

(72) Inventor: Gregory Krantz, Howell, MI (US)

(21) Appl. No.: 16/377,186

(22) Filed: Apr. 6, 2019

Related U.S. Application Data
(60) Provisional application No. 62/658,331, filed on Apr. 16, 2018.

(51) Int. Cl. A47J 31/60; A46B 9/00; B08B 9/087

(52) U.S. Cl. CPC A47J 31/60; A46B 2200/3006; B08B 9/087; A46B 9/005

(57) ABSTRACT

This invention relates to a brush and method for cleaning coffee decanters. The invention makes this necessary task through, simple, and efficient. The invention facilitates the cleaning of both straight sided insulated and semi-globe coffee decanters.

### PRIOR DISCLOSURES

This application claims priority to provisional application No. 62/658,331 filed on Apr. 16, 2016.

### BACKGROUND OF THE INVENTION

This invention relates to a brush specially designed to clean the interior of Bunn style or semi-globe glass coffee pot or decanter. These decanters are used in conjunction with drip coffee machines commonly seen in restaurants and in the workplace. The pot typically has a semi-globe shape with a flat bottom. A drip style coffee machine pours hot water over coffee grounds and dispenses the coffee into the decanter. The coffee is kept hot by resting on a warmer. Over time the glass semi-globe becomes dirty and stained leading to poor quality coffee. Cleaning the interior of the decanter is difficult due to the semi-globe shape, flat bottom, and narrow opening. The opening is too small to fit a hand into the decanter. Brushes and other cleaning tools may be inserted into the pot, but the pot's unique shape makes it difficult to allow for good contact between brush or tool to the interior surface of the pot to allow for sufficient pressure to thoroughly clean the pot.

Although decanter style coffee pots are a common item, a satisfactory method of cleaning them continues to elude restauranteurs. A simple straight brush with a rigid handle is insufficient because proper contact with sides of the pot is difficult due to the its round shape. Poor contact does not allow for sufficient pressure to be applied to clean the pot well. Another approach would be to use a wire brush with a head that could be bent to fit the shape of the pot. Although this allows for good contact on some parts of the interior surfaces, the ability to bend the brush into a shape also means it is flexible. This flexibility prevents consistent and sufficient pressure to be applied to both the sides and bottom. The insufficient pressure makes cleaning laborious, time consuming, and provides poor results. Wire style brushes may have bristles made of plastic or metal. This style of brush bristle also limits the cleaning of oil residues deposited inside the pot. The wire bristles have a limited contact area and therefore scrape through the oil residue instead of wiping through the oil. Wire brush bristles have a very limited useful cleaning life.

At this time the preferred method used by restauranteurs is to clean the decanter is using a saltwater, lemon juice and ice slurry. The ice provides pressure and abrasion, rock salt is an additional abrasion medium; and lemon juice is the cleaning agent. The salt melts the ice and a small amount of water is created to make the mixture into a slurry. The slurry is then sloshed around in the decanter several times; swirling the decanter allows the slurry to move up the sides of the pot and over the bottom. Then the decanter is soaked for several minutes to soften and remove residue and oils from the pot. The slurry is then discarded, the pot rinsed with clean water, and returned to service. A common practice is to soak coffee pots overnight because they cannot be cleaned thoroughly at the close of business.

Commonly, burnt coffee residue and carbon forms on the interior of the decanter when it is left on the warmer after the liquid has evaporated. Additionally, residual calcium and lime also harden onto the interior of the decanter. If these residues are not removed, the decanters develop hot spots that cause premature failure of the special glass used in the pot. These residues cannot be removed with the ice slurry. A scrubbing pad can be inserted into the small opening of the decanter and a stick or serving spoon is used to apply downward pressure through the pot opening for lateral movement to clean the hardened residue. However, this process is difficult because close contact with the curved interior of the pot is not possible. Similarly, straight sided insulated carafes present same challenge to thorough cleaning as the semi-globe decanters.

To maintain service of acceptable tasting coffee, a proper cleaning process must be performed at least daily to all commercial coffee pots. Coffee service is a major component of restaurant operations. A single restaurant coffee station will have as many as 6 coffee decanters. These are used for regular and decaf coffee, and hot water for tea and hot chocolate. A single coffee station can service approximately 50 seats or 10 tables. Larger establishments will have more coffee stations. Gas stations can have up to 10 decanters each. Thus, a simple an efficient cleaning of the decanters is desirable. Thus, it would be beneficial to have a brush that would conform to the interior shape of the decanter which would allow for close contact and the application of enough pressure to provide a thorough cleaning.

### BRIEF SUMMARY OF THE INVENTION

In one embodiment, the invention is a brush having a handle connected to a head. The handle and the head are narrow enough to fit through the opening of a semi-globe coffee decanter. The head is curved in such a manner to closely conform to the spherical interior of the pot. The curved portion of the head allows for excellent contact and pressure with the sides of the pot. In a second embodiment, the curved head further extends to a flat portion. The flat portion of the head allows for excellent contact with the flat bottom of the pot. In a third embodiment, the head is not curved but straight and the end is bent 90 degrees with respect to the portion of the head connected to the handle. This straight embodiment is preferred for cleaning straight sided insulated carafes. The entire brush is made from a rigid material. The rigidity of the brush allows for enough pressure to be applied to the interior surface, which facilitates a thorough cleaning. Many materials of construction could be selected provided they provided they are rigid enough to allow for enough pressure to be applied to the interior of the coffee decanter. The rigid material could be selected from an engineering thermoplastic, said thermoplastic being filled or unfilled, or formed by metal injection molding, or from stamped metal, or machined metal.

The head of the brush has a first side and a second side. To promote the application of pressure the second side must be in a separate plane from the handle. On the second side of the head is an abrasive pad. Such non-limiting examples of an abrasive pad could be grit impregnated into the second side of the brush head or multiple protrusions molded into the second side of the head. Furthermore, the abrasive pad could be incorporated into the brush by over-molding.

Preferably, however, the abrasive pad is not integral to the head but is separate and attached to the second side of the head by some means. Unlike the former examples, where the means of attachment of the abrasive pad is accomplished by molding into the head, the abrasive pad can be attached to the second side by the means of an adhesive or by welding the pad to the second side. More preferably the adhesive pad is removably attached to the second side of the head. Removable attachment can be accomplished by several non-limiting means such as a snap-fit piece, or tight-fitting sock that fits snugly over the head. Most preferably, however, would be attachment by a hook and loop type fastening system, a well know non-limiting example being Velcro®.

The abrasive nature of the pad can be achieved by using any number of abrasive materials, non-limiting examples could include steel, bronze, or copper wool, or grit. Preferably the abrasive nature obtained by using a non-woven polymer of cellulose, nylon or spun polyolefin made abrasive through the additions of aluminum oxide or titanium dioxide. One non-limiting example being Scotch-Brite™. Furthermore, the degree of abrasion can be modified by selection of the abrasive medium. Low abrasive media such as cloth, felt, sponge, or rubber could be selected as well. The degree of abrasion would be selected by the materials of construction of the interior of the decanter. The advantages of the invention are that the shape of the brush allows for close contact with the interior surfaces. The interior can be cleaned in two axes at the same time reducing cleaning time; and the rigidity of the brush allows for high level of pressure to be applied to remove of stains and stubborn residues.

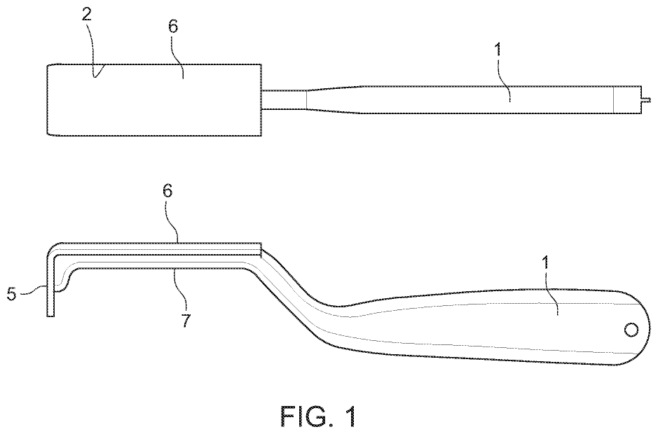

FIG. 1 is a drawing of a straight head version of the invention.

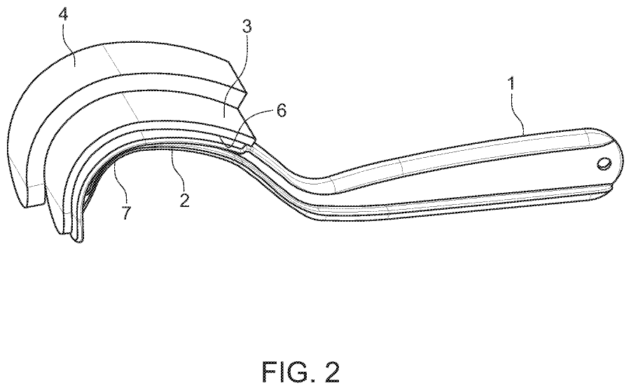

FIG. 2 is an exploded view of the curved head version of the invention.

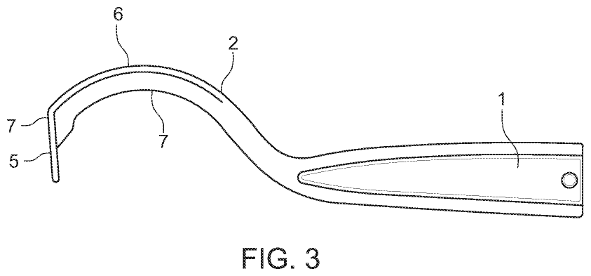

FIG. 3 is a drawing of the bent curved head version of the invention.

### DETAILED DESCRIPTION OF THE INVENTION

In one embodiment, referring to FIG. 1, the invention comprises a brush having a handle (1) and a head (2), where the head has a first side (7) and a second side (6) and the end of the head (5) is bent 90 degrees from the second side (6). In another embodiment, referring to FIG. 2, of the invention the head (2) is curved. In yet another embodiment of the invention, referring to FIG. 3, the end of the curved head is bent 90 degrees (5) with respected to the second side (6). For all the previous embodiments the abrasive pad (4) is attached to the second side (6). One, non-limiting attachment means is an adhesive backed Velcro pad (3). Having set forth the general nature and specific embodiments of the invention, the true scope is now particularly pointed out in the appended claims.

What is claimed is:

1. A brush for cleaning coffee pots comprising: a handle and a head; where the head has a first side and a second side, where the second side is opposite the first side; where the second side is in a separate plane from the handle; on the second side is an attachment means that allows for the firm attachment of an abrasive pad to the second side, and the material of construction of the handle and the head is a rigid material.

2. The brush of claim 1 where said head is curved.

3. The brush of claim 2 where the abrasive pad can contact at the side and the bottom of a semi-globe coffee decanter simultaneously.

4. The brush of claim 1 where said head has a first end and a second end; where the first end is attached to the handle and the second end is bent at 90 degrees relative to the first end.

5. The brush of claim 4 where the abrasive pad can contact the side and bottom of a cylindrical coffee decanter simultaneously.

6. A method for cleaning a coffee decanter comprising: inserting a brush of any one of the proceeding claims into a coffee decanter, contacting the abrasive pad of the brush against the side and bottom of the decanter simultaneously, applying pressure, and then working the brush over the entire bottom and sides of the coffee decanter.
